(19) United States
(12) Patent Application Publication
(10) Pub. No.: US 2008/0152411 A1
(43) Pub. Date: Jun. 26, 2008

(54) Graphic Arts Machine, Such as a Printing Press, Having a Browser-Based Operator Control Device for Auxiliary Equipment

(75) Inventors: Edelbert Konig, Kronau (DE); Holger Leonhardt, Meckesheim (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 11/963,955

(22) Filed: Dec. 24, 2007

(30) Foreign Application Priority Data
Dec. 23, 2006 (DE) 102006061486.0

(51) Int. Cl. B41J 21/17

(52) U.S. Cl. 400/70

(57) ABSTRACT

A machine for the graphic arts industry, such as a printing press, includes an operator control device having a display device and an input device. Auxiliary devices have their own dedicated control for communicating with the operator control device over an electronic communication network. The auxiliary devices send signals over the electronic communication network to the operator control device. The auxiliary devices have a user interface displayable on the display device and the signals contain a network address from which the user interface is accessible.

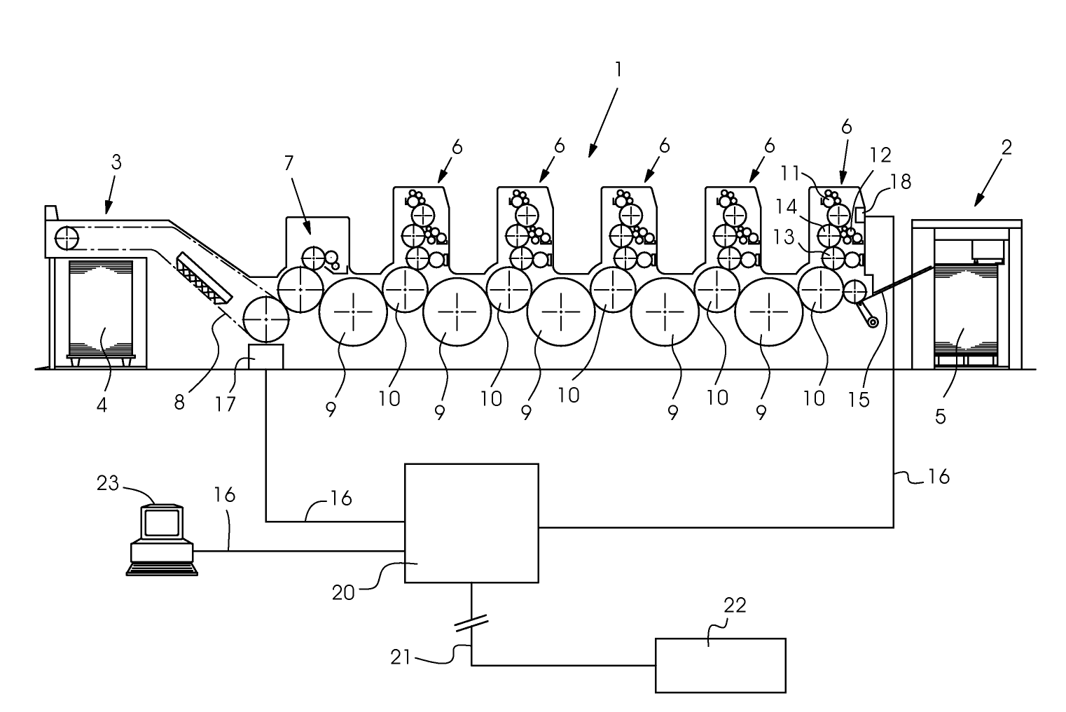

### CROSS-REFERENCE TO RELATED APPLICATION

This application claims the priority, under 35 U.S.C. § 119, of German Patent Application DE 10 2006 061 486.0, filed Dec. 23, 2006; the prior application is herewith incorporated by reference in its entirety.

### BACKGROUND OF THE INVENTION

### Field of the Invention

The present invention relates to a graphic arts machine, such as a printing press, having a browser-based operator control device for auxiliary equipment, a display device and an input device. The auxiliary equipment have their own control for communicating with the operator control device over an electronic communication network.

A plurality of peripheral or auxiliary devices is required to operate a printing press. Those auxiliary devices may provide compressed air or include a module for drying finished printed products, for example. External modules may be used to supply ink to the ink fountain. When those auxiliary devices or modules are put into operation for the first time, they need to be adapted to the configuration of the printing press. Today it is common practice to equip auxiliary devices for printing presses with operator control devices of their own for start-up and servicing purposes. This means that, in order to be able to carry out the necessary service and configuration measures, the operating personnel must connect an operator control device including a screen and a keyboard to the respective auxiliary device through the use of a cable. Of course, it is likewise possible for every auxiliary device to be delivered ex works with an operator control device of its own. Since printing presses have a relatively high number of auxiliary devices that require relatively infrequent maintenance and configuration measures, the equipment of all of the auxiliary devices with displays and operator control devices is costly and mostly avoided.

The use of what is known as a web server, for example in SPS controls, is known from automation technology. Such a system is known, for example, from European Patent EP 1 354 249 B1, corresponding to U.S. Pat. No. 6,640,140. In accordance with that document, web servers are included in control modules of industrial control systems. Those web servers can contact other computers, for example through the web, and can receive data for the control module. The SPS control that is equipped with the web server in turn controls the connected devices of the machine. The data of the web server of the SPS control can be accessed from a remote computer through the use of the web server. However, the document does not provide any information on how to configure such a control including a web server in an easy and cost-saving way.

### BRIEF SUMMARY OF THE INVENTION

It is accordingly an object of the invention to provide a graphic arts machine, such as a printing press, having a browser-based operator control device for auxiliary equipment, which overcomes the hereinafore-mentioned disadvantages of the heretofore-known devices of this general type and which provides an easy and reliable way of configuring auxiliary devices that are connected to the machine and do not have a corresponding operator control device.

With the foregoing and other objects in view there is provided, in accordance with the invention, a machine for the graphic arts industry. The machine comprises an operator control device having a display device and an input device, an electronic communication network, and auxiliary devices having their own dedicated control for communicating with the operator control device over the electronic communication network. The auxiliary devices send signals over the electronic communication network to the operator control device. The auxiliary devices have a user interface displayable on the display device and the signals contain a network address from which the user interface is accessible.

Therefore, the operator control device according to the invention includes a display device and an input device for controlling the graphic arts industry machine. The machine may be a printing press, a folding machine, or other print finishing machines. Printing presses, in particular, include a number of auxiliary devices that need to be put into operation and serviced at regular intervals. It is not uncommon to retrofit printing presses with additional auxiliary equipment that had not been standard equipment when the press was originally delivered to the customer. These auxiliary devices then need to be integrated into the control of the printing press. Appropriate configuration is required for this purpose. The auxiliary devices have an electronic control of their own, which permits interfacing to integrate the device with an electronic communication network of the printing press.

In accordance with another feature of the invention, such an electronic communication network may be a bus system such as a CAN bus or a process field bus. New network technologies based on the Ethernet protocol such as Ethernet Powerlink or Ethercat may likewise be used. The control of the auxiliary devices can contact the operator control device of the printing press through the electronic network. Since the auxiliary devices do not have their own display and input device, not the least of which is for cost-saving reasons, the auxiliary devices must be put into operation and serviced through the use of the operator control device of the printing press. If the auxiliary devices have been retrofitted, for example, the required operating functions, in particular electronic user interfaces for the screen of the operator control device of the printing press, are not present or have not been installed. In accordance with the present invention, such an installation can be made quite easily. As soon as new auxiliary devices are connected to the electronic communication network of the machine, the new devices emit signals to the electronic communication network. These signals reach the operator control device of the machine. In accordance with the invention, the emitted signals of the auxiliary devices include an electronic network address, from which a user interface that is associated with the respective auxiliary device and can be displayed on the operator control device can be called up. In this way, the user interface associated with the auxiliary device can be accessed at the established network address from the operator control device of the machine. Consequently, the operating functionalities of the auxiliary devices are now available at the operator control device of the machine. For this purpose, the operator control device of the machine expediently includes at least one computer in which the user interface downloaded from the network address can be stored for further operations. However, it is likewise possible for the user interface to be only stored as a temporary control device, since it is possible to directly access the network address of the user interface through the operator control device.

In accordance with a further particularly advantageous feature of the invention, which is derived from what has been explained above, the user interface of the auxiliary devices is displayable on the display of the machine in a browser application. Such a browser application may, for example, be an Internet web browser. This browser software is capable of displaying HTML, XML, and other standardized formats. Since the network address of the browser application has been made known to the computer of the operator control device when the auxiliary device was installed, the user interface of the auxiliary device can now be displayed from this network address in the Internet browser on the screen of the operator control device of the machine. The user interface of the auxiliary device will be displayed in the browser window in a manner similar to that of an Internet page. Due to the use of standardized formats for the browser application such as XML, it is possible to access and operate any desired browser applications of new auxiliary devices through the user interface of the operator control device. Thus, flexible upgrading of the machine through the use of new auxiliary devices is possible at any time.

In accordance with an added feature of the invention, the operator control device is connected to the machine computer for controlling the graphic arts industry machine. In this case, the operator control device of the machine converts the operating personnel's operating instructions into control commands for the actuators of the printing press. This means that the machine computer can directly control the actuators and electric motors of the printing press. The connection between the operator control device and the machine computer may be implemented through the use of the same electronic communication network to which the auxiliary devices with their dedicated controls are connected. In this case, the electronic control of the entire machine is interconnected through the use of a common electronic communication network, making a separate network unnecessary.

In accordance with an additional feature of the invention, the communication network has a network interface with the Internet. This network interface can be used by the control units that are connected to the electronic communication network of the machine, for example the operator control device of the machine, the machine control, and auxiliary devices, may exchange data with remote computers. A great advantage of this is that the user interface of the auxiliary devices, which is displayable on the display device of the machine, can be stored on a remote computer and can be accessed there for the purpose of displaying the user interface on the display device of the machine. This means that the respective user interface of the auxiliary device does not necessarily have to be delivered together with the auxiliary device itself. Instead, the control of the auxiliary device may only contain the network address at which the associated user interface is stored on a remote computer, and may transmit this network address to the communication network of the machine. This remote computer may, for example, be located at the manufacturer of the auxiliary device. The manufacturer may have the user interface of the auxiliary device available at this remote computer. This especially simplifies updating of user interfaces because the updated version of a user interface does not have to be sent to an auxiliary device. Instead, the user interface only needs to be updated on the remote computer of the manufacturer. The manufacturer only needs to update the user interface on one computer. The updated user interface will then be directly accessible from the operator control device of the machine through the network interface with the Internet, and the corresponding function of the respective auxiliary device can be operated.

In accordance with yet another feature of the invention, it is likewise possible to store the user interface as a browser application in the memory of the auxiliary device. This configuration does not require an Internet connection to access the user interface. In this case, connecting the auxiliary device to the communication network of the machine is sufficient to put the auxiliary device in operation.

In accordance with yet a further feature of the invention, the user interface of the auxiliary devices, which is displayable on the display device, includes data links to further functional components of the user interface that are located on further computers. As a result of such a construction, it is possible to provide individual components of the user interface of the auxiliary device on a number of computers. This means that, for example, the main part of the user interface may be stored in the control computer of the respective auxiliary device. For special or more comprehensive functions, links to network addresses that may belong to remote computers are provided on the user interface of the auxiliary device that is displayed on the operator control device of the machine. The data links may, in particular, be Internet links, constructed as “hyperlinks”, which may conceal further components of the user interface of the auxiliary device. For instance, the auxiliary device may be delivered ex works with standard functions stored in the memory of the auxiliary device, whereas additional functions are enabled through such Internet links. An advantage of such a construction is that these additional functions, which may not have been implemented when the auxiliary device was delivered, do not need to be transmitted to the auxiliary device. Instead, they can be provided automatically through the use of the data link that is present in the user interface when the auxiliary device is delivered.

In accordance with yet an added feature of the invention, access to functions on the user interface of the auxiliary device may be granted depending on access rights of an operator. In this case, when the user interface of the auxiliary device is accessed through the browser of the operator control device. A window asking the operator to identify himself or herself will be displayed before the user interface is started. Once the operator has input his or her user ID and password, he or she will be given access to the user interface of the auxiliary device. In this context, each password and user ID of a person may be given controlled access to functions of the user interface. For example, only a member of the service team of the manufacturer of the device may be given access to maintenance and servicing functions. When the operating personnel of the printing press logs on to the user interface of the auxiliary device with their user ID and password, they may only be given the right to change settings on the user interface as required to operate the printing press. Maintenance and servicing functions may be at least partly blocked.

In accordance with a concomitant feature of the invention, the machine is a printing press.

Other features which are considered as characteristic for the invention are set forth in the appended claims.

Although the invention is illustrated and described herein as embodied in a graphic arts machine, such as a printing press, having a browser-based operator control device for auxiliary equipment, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

The FIGURE of the drawing is a diagrammatic, longitudinal-sectional view of a printing press with two auxiliary devices that are controllable through an operator control device of the printing press illustrated in a block diagram.

### DETAILED DESCRIPTION OF THE INVENTION

Referring now in detail to the single FIGURE of the drawing, there is seen an operator control device in accordance with the invention, implemented in a printing press 1 that includes five printing units 6 and a varnishing unit 7. Each of the printing units 6 includes a blanket cylinder 13, a plate cylinder 14 and an inking unit 11. In addition, there is a dampening unit 12 for providing dampening solution. In the illustrated example, the printing units 6 are of identical construction. However, this is not necessary the case. The printing press 1 shown in the FIGURE is a sheet-fed printing press including a feeder 2 for feeding sheet-type printing material from a feeder stack 5 to the printing press over a conveying device 15. Individual color separations are successively printed onto the sheets in the printing units 6. The illustrated exemplary printing press is a five-color press that includes the varnishing unit 7 for varnishing the sheets after printing. The finished sheets are dried in a dryer device 8 and are then deposited on a delivery stack 4 in a delivery 3. Impression cylinders 10 and transport cylinders 9 convey the individual sheets through the printing press 1.

All motors and actuators of the press 1 are controlled (whether or not in a closed loop) by a central machine computer 20, which forms a main element of a machine control system. As is illustrated in the FIGURE, the press 1 is equipped with auxiliary devices, namely the dryer device 8 and the inking unit 11. In this context, the inking unit 11 is to be considered an auxiliary device inasmuch as it includes an ink supply device with cartridges that continuously feed ink to an ink fountain of the inking unit 11 during printing. This ink supply device is controlled by an ink feed module 18. In a similar way, the dryer device 8 is controlled by a dryer control 17. Each of the two controls 17, 18 includes a computer, which controls the respective auxiliary device and has a network interface for connecting the respective control 17, 18 to the machine computer 20 over a communication connection 16. The communication connection 16 may be a CAN bus or an Ethernet-based network. Other network technologies are also possible.

As is illustrated in the FIGURE, the machine computer 20 is connected to an operating computer 23. This operating computer 23 is preferably a conventional computer with a screen and an input device such as a keyboard and mouse. The operating computer 23 may communicate with the machine computer 20 through the same network connection 16 as the controls 17, 18 of the auxiliary devices. In addition, it is apparent from the FIGURE that the machine computer 20 has an interface for accessing the Internet 21. The machine computer 20 can communicate with remote computers 22 over the Internet 21 through this network interface. Thus, it is possible for a printing press 1 located in a print shop to contact a maintenance and administration server 22 at the manufacturer of the press. In this way, the manufacturer of the press can send programs for updates to the control computer 20 of the printing press 1.

The printing press 1 is controlled by the operating computer 23. The machine computer 20 converts operator inputs coming from the operating computer 23 into actuating commands for the motors and actuators of the printing press 1. The auxiliary devices 8, 11 located in the press, however, must initially be configured for future operation. This is necessary, in particular, when the press 1 has been retrofitted with auxiliary devices. In order to dispense with the need to equip the auxiliary devices 8, 11 with screens and operating elements of their own for installation purposes, this configuration may be carried out in accordance with the invention through the use of operating processes through the operating computer 23. Since the operating computer 23 initially does not have appropriate operating elements for the auxiliary devices 8, 11, the operating system in accordance with the invention is constructed in such a way that once the auxiliary devices 8, 11 have been connected and switched on, information is sent to the communication network 16. These data contain a respective network address of the storage location of the associated user interface of the respective auxiliary device 8, 11. This network address may, for example, be the memory of the dryer control 17, or of the ink feed module 18. In this case, the user interface would be located directly in the control unit of the respective auxiliary device 8, 11. However, it is likewise possible for the network address to refer to a remote computer 22. In this case, the operating computer 23 would access the user interface stored on the remote computer 22 through the communication network 16 and an Internet connection 21. The operating computer 23 accesses the user interface through an Internet browser as is commonly used today for accessing the Internet. Such an Internet browser can be used to access and display Internet pages. Like an Internet page, the user interface is stored in XML or a similar programming language so that it can easily be displayed by any standard Internet browser available on the operating computer 23. The operator can now use the user interface that is now being displayed on the operating computer 23 to access the dryer control 17 or the ink feed module 18 to configure or service the auxiliary devices, i.e. the dryer device 8 and the inking unit 11. It is likewise possible for parts of the user interface to be stored on the computers 17, 18 of the auxiliary devices 8, 11, while further operating modules may be stored on the remote computer 22. In this case, the user interfaces stored on the computers 17, 18 contain what are known as Internet links, which refer to the storage location of the user interface modules in the remote computer 22. In this manner it is possible to use additional functions that had not been stored in the control modules 17, 18 when the auxiliary devices were delivered. As soon as the missing software modules of the user interface are available on the remote computer 22, they may be activated through the links in the user interfaces of the dryer device 17 and the ink feed module 18. Due to the use of an Internet-based web browser for displaying the user interface and due to the accompanying standardization as well as due to the provision of the user interface through an electronic network address, easy updating and easy installation of auxiliary devices and their controls become possible.

1. A machine for the graphic arts industry, the machine comprising:
an operator control device having a display device and an input device;
an electronic communication network;
auxiliary devices having their own dedicated control for communicating with said operator control device over said electronic communication network;
said auxiliary devices sending signals over said electronic communication network to said operator control device;
said auxiliary devices having a user interface displayable on said display device; and
said signals containing a network address from which said user interface is accessible.

2. The machine according to claim 1, wherein said electronic communication network is a bus system.

3. The machine according to claim 1, wherein said electronic communication network is a CAN bus.

4. The machine according to claim 1, wherein said user interface of said auxiliary devices is displayable on said display device in a browser application.

5. The machine according to claim 1, which further comprises a machine computer, said operator control device being connected to said machine computer for controlling the machine.

6. The machine according to claim 1, wherein said communication network has a network interface with the Internet.

7. The machine according to claim 6, wherein said network interface of said communication network establishes a connection to a remote computer over the Internet.

8. The machine according to claim 7, wherein said user interface of said auxiliary devices displayable on said display device is stored on the remote computer and is accessible from the remote computer to be displayed on said display device.

9. The machine according to claim 1, wherein said user interface of said auxiliary devices displayable on said display device has operating functions for putting at least one of said auxiliary devices into operation.

10. The machine according to claim 1, wherein said user interface of said auxiliary devices displayable on said display device includes data links to further functional components of said user interface located on remote computers.

11. The machine according to claim 1, wherein each of said auxiliary devices has a respective unambiguous network address.

12. The machine according to claim 1, wherein one of said auxiliary devices includes a computer with a memory for storing said user interface of said one auxiliary device displayable on said display device.

13. The machine according to claim 1, wherein access to functions of said user interface of said auxiliary devices is granted depending on access rights of an operator.

14. The machine according to claim 1, wherein the machine is a printing press.

15. A printing press, comprising:
a print operator control device having a display device and an input device;
an electronic communication network;
auxiliary printing devices having their own dedicated control for communicating with said print operator control device over said electronic communication network;
said auxiliary printing devices sending signals over said electronic communication network to said print operator control device;
said auxiliary printing devices having a user interface displayable on said display device; and
said signals containing a network address from which said user interface is accessible.
